(19) United States
(12) Patent Application Publication
(10) Pub. No.: US 2015/0121707 A1
(43) Pub. Date: May 7, 2015

(54) TRIMMER HEAD

(71) Applicant: CHERVON INTELLECTUAL PROPERTY LIMITED, Road Town (VG)

(72) Inventors: Hanzheng Li, Nanjing (CN); Toshinari Yamaoka, Nanjing (CN)

(73) Assignee: CHERVON INTELLECTUAL PROPERTY LIMITED

(21) Appl. No.: 14/529,405

(22) Filed: Oct. 31, 2014

(30) Foreign Application Priority Data
Nov. 5, 2013 (CN) 201310542646.8

(51) Int. Cl. A01D 34/416

(52) U.S. Cl. CPC A01D 34/4161
USPC 30/276

(57) ABSTRACT

A trimmer head in which a cutting line can be loaded to a spool includes a housing connectable to a driving shaft. A line outlet is disposed in the housing and the spool is connected to the housing. In a line winding mode, the spool includes a position where an end of a line leading channel is aligned with the line outlet and a cutting line may enter the line leading channel and will be in clearance fit with the line leading channel. When the spool is rotated with respect to the housing, a portion of the cutting line in the line leading channel is pressed tightly therein, and the portion of the cutting line extending from the line leading channel can be pulled toward the spool.

### RELATED APPLICATION INFORMATION

This application claims the benefit of CN 201310542646.8, filed on Nov. 5, 2013, the disclosure of which is incorporated herein by reference in its entirety.

### BACKGROUND

The subject disclosure is related to garden tools and, more particularly, to a trimmer head of a string trimmer.

A string trimmer is a common garden tool, the principle of which is uses a motor or an engine to drive a trimmer head to rotate at a high speed. A cutting line is wound on a spool in the trimmer head and the ends of the cutting line extend outside of the housing through holes on the housing. When the trimmer head is rotating at a high speed, the cutting line is also rotating at a high speed to carry out a cutting action.

When the cutting line extending outside of the housing is cracked or worn, new cutting line needs to be fed. There are multiple ways to feed line, such as manual feed, bump feed or auto feed. If, however, the cutting line on the spool runs out, the cutting line must be manually wound on the spool by separating the housing. There are at least two disadvantages to this approach: first, separating the housing to wind the cutting line manually wastes a lot of time, and during the winding process, two winding cutting lines may be knotted to each other. If the two cutting lines are knotted, the two cutting lines will not be paid out correctly, which brings trouble to the users and wastes time, and further reduces operators' working efficiency.

### SUMMARY

To overcome these and other problems, the following describes a trimmer head which can wind cutting line to a spool conveniently and improve an operators' working efficiency.

To achieve these objectives, the described trimmer head includes a housing and a spool. The housing is connected to a driving shaft and a line outlet is disposed in the housing. The spool is connected to the housing. When in the driving mode, the spool is rotated with the housing, and, when in the line winding mode, the spool is rotatable relative to the housing. The spool includes an inwardly extending line leading channel whose diameter is larger than that of a cutting line. In the line winding mode, the spool includes a position where the end of the line leading channel is aligned with the line outlet and the cutting line will enter the line leading channel through the line outlet with the cutting line being in clearance fit with the line leading channel. When the spool is rotated with respect to the housing, the portion of the cutting line in the line leading channel is pressed tightly therein, and the portion of the cutting line extending from the line leading channel is pulled toward the spool.

The advantage of the present invention lies in that the cutting line can be wound to the spool of the trimmer head conveniently without being separated from the housing. And further, if two cutting lines are wound on the spool, the two cutting lines will not be knotted to each other, which brings convenience to operators and improves operators' working efficiency.

### BRIEF DESCRIPTION OF THE DRAWINGS

FIG. 1 is a schematic drawing showing an exemplary trimmer head constructed according to the description which follows.

FIG. 2 is an exploded drawing showing the trimmer head of FIG. 1.

FIG. 3 is a section view showing the trimmer head of FIG. 1.

FIG. 4 is a front view showing the trimmer head of FIG. 1.

FIG. 5 is a top view showing the trimmer head of FIG. 1.

FIG. 6 is a section view of the trimmer head along line A-A′ of FIG. 4 when the spool is at the line inserting position.

FIG. 7 is a section view of the trimmer head when the spool of FIG. 6 has been rotated for an angle.

FIGS. 8A-8C are schematic drawings showing relative positions of the upper housing and the lower housing in the line winding mode.

FIGS. 9A-9E are schematic drawings showing relative positions of the upper housing and the lower housing in the line feeding mode.

FIG. 10 is a schematic drawing showing a winding of a cutting line to the spool by the line gripping slot.

### DETAILED DESCRIPTION OF PREFERRED EMBODIMENTS

An exemplary trimmer head is now described in detail with reference to the drawings and specific embodiments.

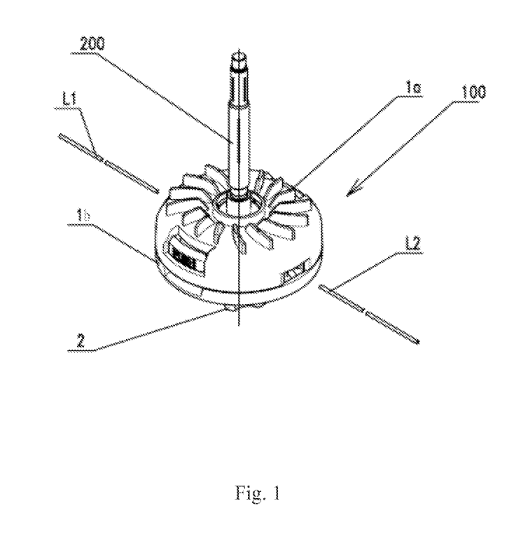

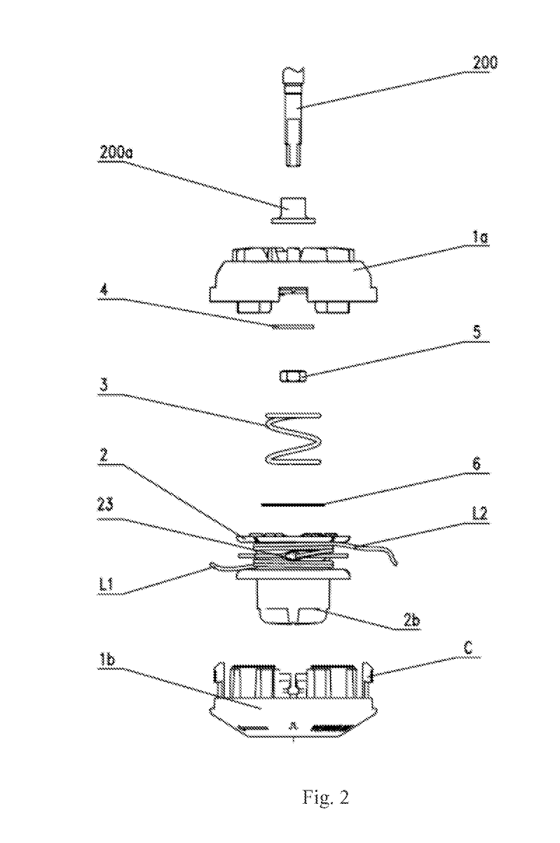

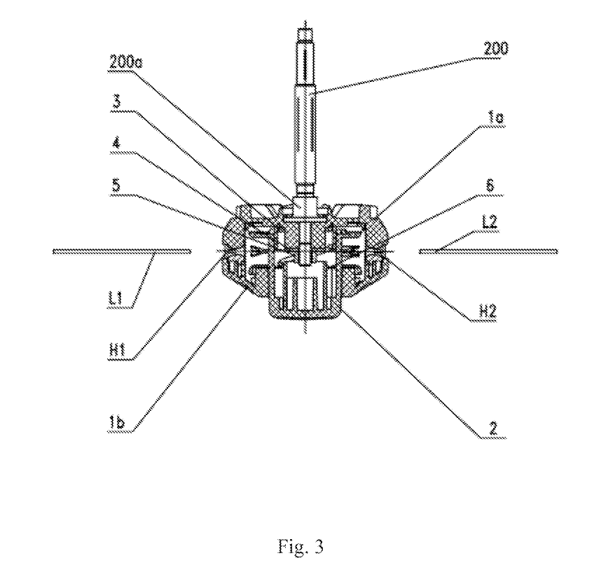

Referring to FIG. 1-FIG. 3, a trimmer head 100 is capable of connecting to a driving shaft 200 of a string trimmer, and the trimmer head 100 can be operated in a driving mode, a line winding mode and a line feeding mode. The trimmer head 100 includes an upper housing 1a, a lower housing 1b, a spool 2, a spring 3, a washer 4 and a nut 5. The upper housing 1a is connected to the driving shaft 200 through the washer 4 and the nut 5. The driving shaft 200 is connected to the upper housing 1a through a sleeve 200a, and two diametrically opposed line outlets H1, H2 are disposed on the upper housing 1a. The lower housing 1b and the upper housing 1a are connected by a clip C, and the spool 2 is disposed in the cavity formed by the upper housing 1a and the lower housing 1b, the bottom portion 2a of the spool 2 is exposed outside of the outer of the lower housing 1b, and the upper housing 1a, the lower housing 1b and the spool 2 are rotated around a same axis. One end of the spring 3 touches the upper housing 1a, and the other end of the spring 3 touches the spool 2 for limiting the vertical movement of the spool 2. Further, a washer 6 is disposed at the position where the spring 3 touches the spool 2.

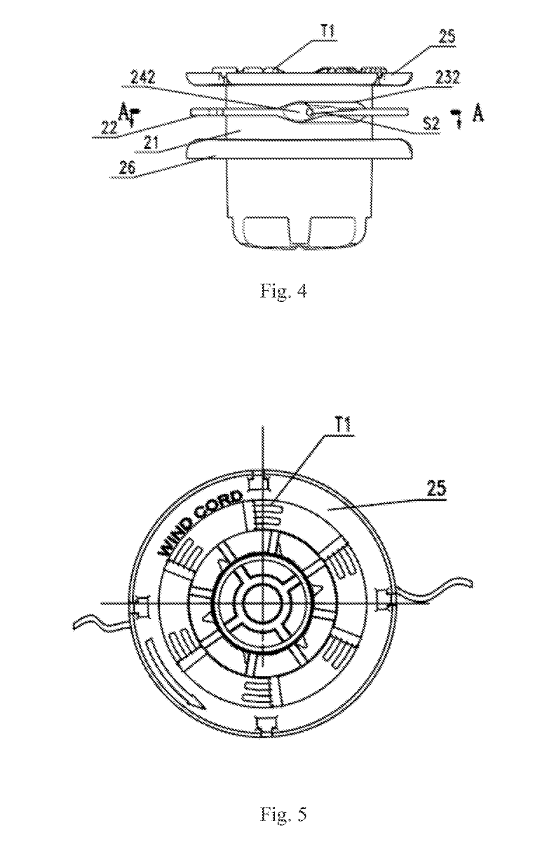

Referring to FIG. 4-FIG. 6, the spool 2 includes a cylindrical body 21 and a flange 22 projecting radially therefrom. The cylindrical body 21 is used for winding the cutting line. In this embodiment, two line leading channel 231, 232 are formed on the flange 22, the line leading channel 231, 232 extend from the circumference of the flange 22 to the inner of the flange 22, and an angle a is formed between the axis of the line leading channel 231 and that of the line outlet H1. The diameter of the line leading channel 231 is larger than that of a cutting line L1, so that when the cutting line L1 enters the line leading channel 231 through the line outlet H1, the cutting line L1 is in clearance fit with the line leading channel 231, and the cutting line L1 may move freely therein, and the operator may draw the cutting line L1 out from the line leading channel 231 easily.

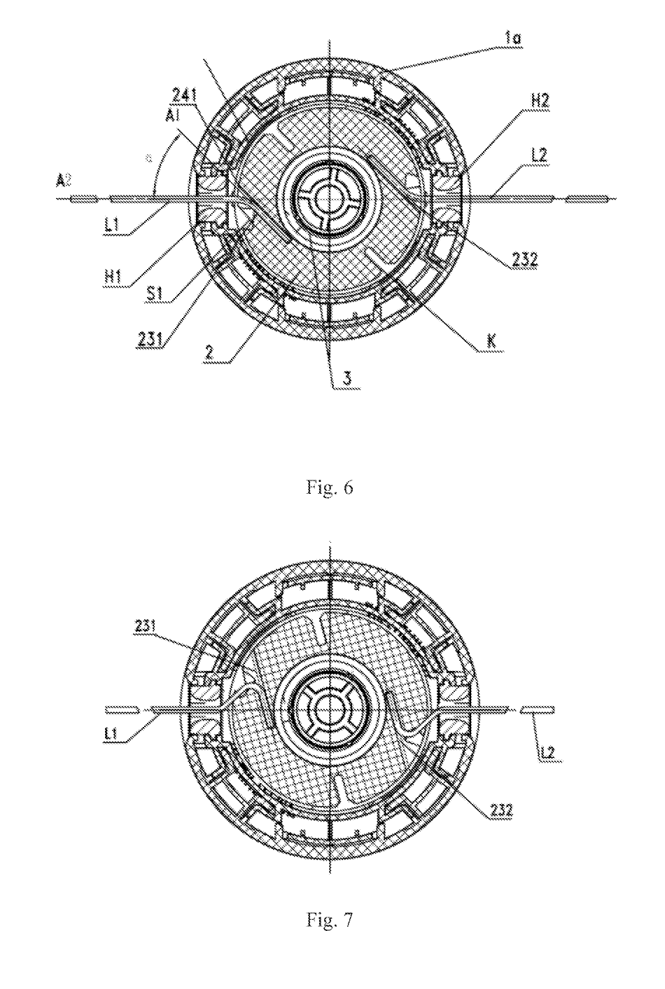

FIG. 7 is a section view of the trimmer head when the spool of FIG. 6 has been rotated for an angle, and the port 241 of the line leading channel 231 is not aligned with the line outlet H1. A part of the cutting line L1 in the line leading channel 231 is pressed tightly therein under the cooperation of the inner wall of the housing and the sidewall of the port 241 and will not fall out from the line leading channel 231. Then the spool 2 will continue to rotate with respect to the upper housing 1a and the lower housing 1b, the cutting line L1 is led towards the cylindrical body 21 of the spool 2 and further to wind on the cylindrical body 21.

In this embodiment, the port 241 of the line leading channel 231 is funnel-shaped and tapers inwardly along the extending direction of the line leading channel 231.

Further, a guiding surface S1 is formed at the port 241 of the line leading channel 231. In the line winding mode, the part of cutting line L1 in the line leading channel 231 is pressed tightly in the line leading channel 231 under the cooperation of the inner wall of the upper housing 1a and the lower housing 1b and the sidewall of the port 241 of the line leading channel 231, and a part of the cutting line L1 extending from the port 241 to the circumference of the flange 22 will be guided to the cylindrical body 21 by the guiding surface S1. In this embodiment, the flange 22 is formed at the middle portion of the circumference surface of the cylindrical body 21 and dividing the cylindrical body 21 into an upper portion and a lower portion. Two line leading channels 231, 232 are formed on the flange 22 for being inserted by the cutting lines L1, L2 respectively. The guide surfaces S1, S2 are used to guide the cutting lines L1, L2 to the upper portion or the lower portion of the cylindrical body 21 respectively, then the cutting lines L1, L2 will wind on the upper portion or the lower portion of the cylindrical body 21, wherein, in this embodiment, the guide surface S1 of the line leading channel 231 is used to guide the cutting line L1 to the lower portion of the cylindrical body 21, and the guide surface S2 of the line leading channel 232 is used to guide the cutting line L2 to the upper portion of the cylindrical body 21

Further, in this embodiment, the cylindrical body 21 of the spool 2 includes an upper flange 25 and a lower flange 26, and the upper flange 25 includes a set of upper projecting teeth T1, the lower flange 26 includes a set of lower projecting teeth T2, and the lower housing 1b includes a set of driving teeth T3 cooperating with the set of lower projecting teeth T2, the upper housing 1a includes a set of stopping teeth T4 cooperating with the set of upper projecting teeth T1.

And in this embodiment, the set of upper projecting teeth T1 and the set of lower projecting teeth T2 are arranged uniformly on the upper flange 25 and the lower flange 26, and the set of upper projecting teeth T1 and the set of lower projecting teeth T2 are staggered in the direction of the axis of the spool. Further, the upper projecting tooth T1 and the lower projecting tooth T2 are of the same shape and both include a vertical surface VS and an inclined surface CS. And the driving tooth T3 and the stopping tooth T4 are also of the same shape and are aligned with each other in the direction of the axis of the spool.

In other embodiments, the upper projecting tooth T1 and the lower projecting tooth T2 may be aligned with each other in the direction of the axis of the spool. And the driving tooth T3 and the stopping tooth T4 may be staggered in the direction of the axis of the spool.

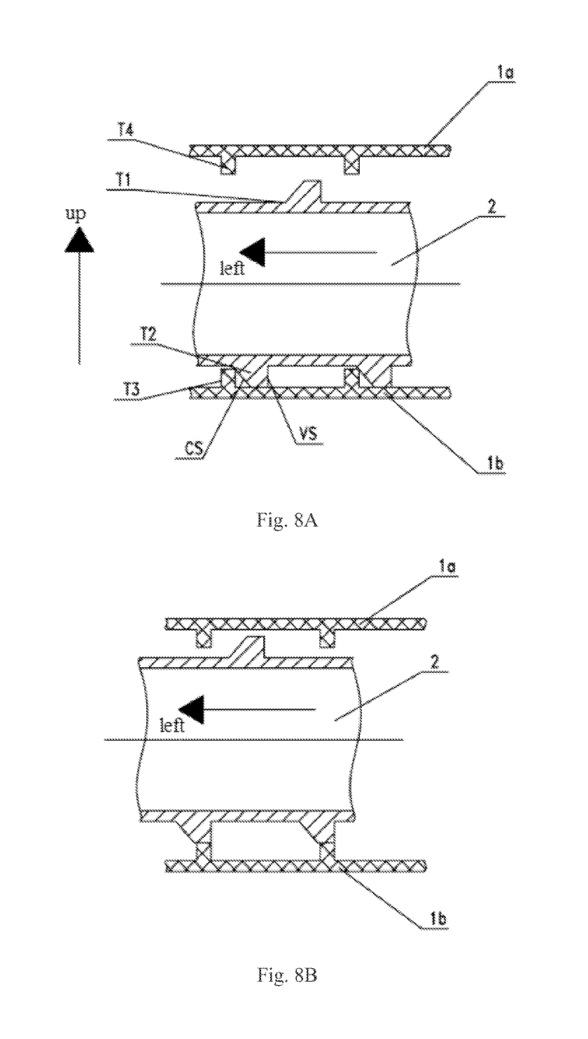

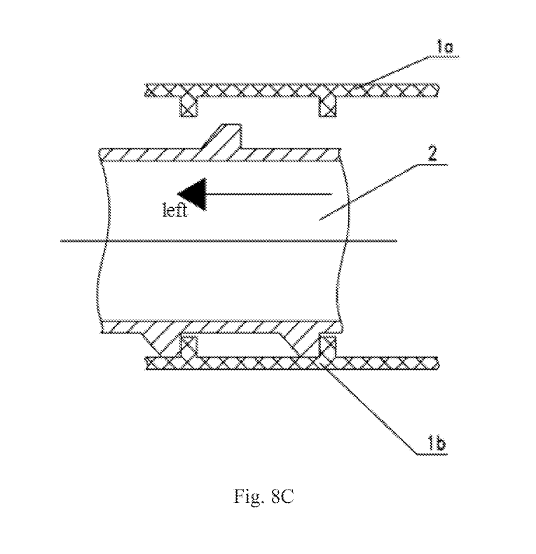

In practice, a cutting line needs to be wound on the spool 2 first. Referring to FIG. 8A-8C, first, the spool 2 is rotated to the right. When the inclined surface CS of the lower projecting tooth T2 contacts the driving tooth T3 shown in FIG. 8A, the inclined surface CS will slide up along the driving tooth T3 under the operation of the operator to the top of the driving tooth T3, as shown in FIG. 8B, and continue to rotate the spool along the direction of the arrow, the lower projecting tooth T2 will pass over the driving tooth T3 as shown in FIG. 8C, and, if the spool continues to be rotated along the direction of the arrow, the above process will be repeated until the cutting line is wound.

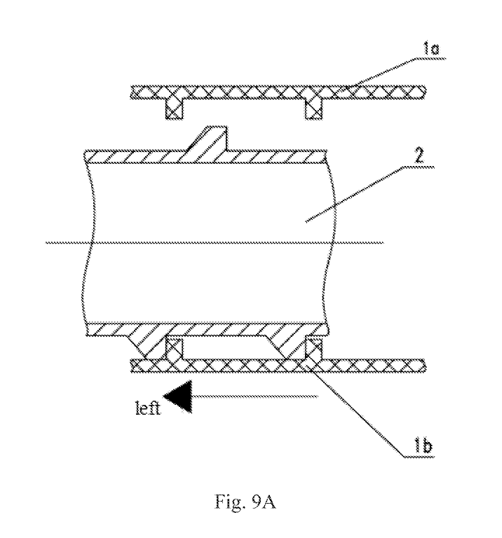

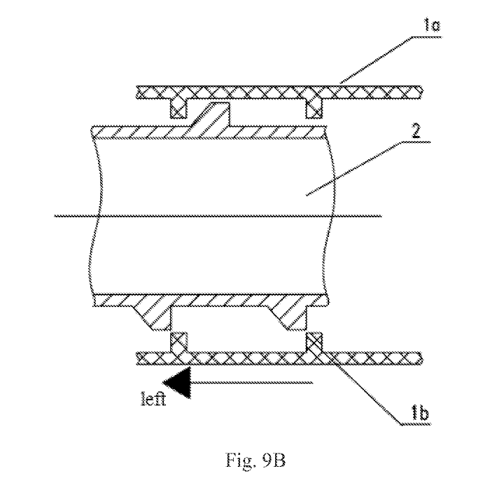

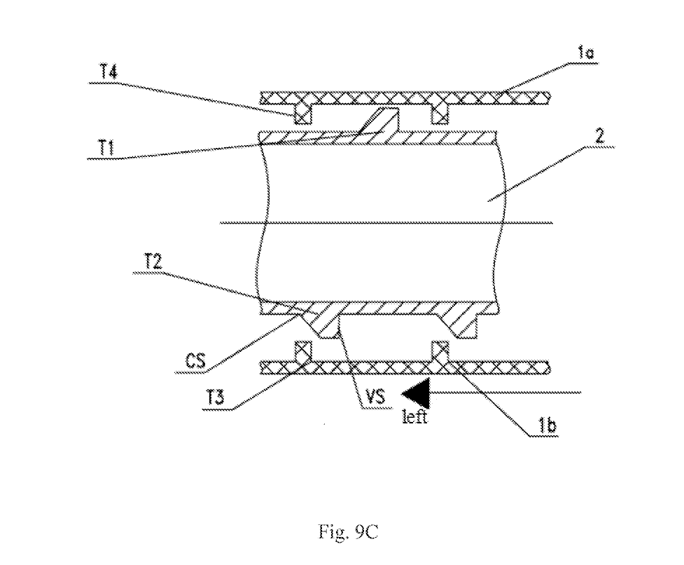

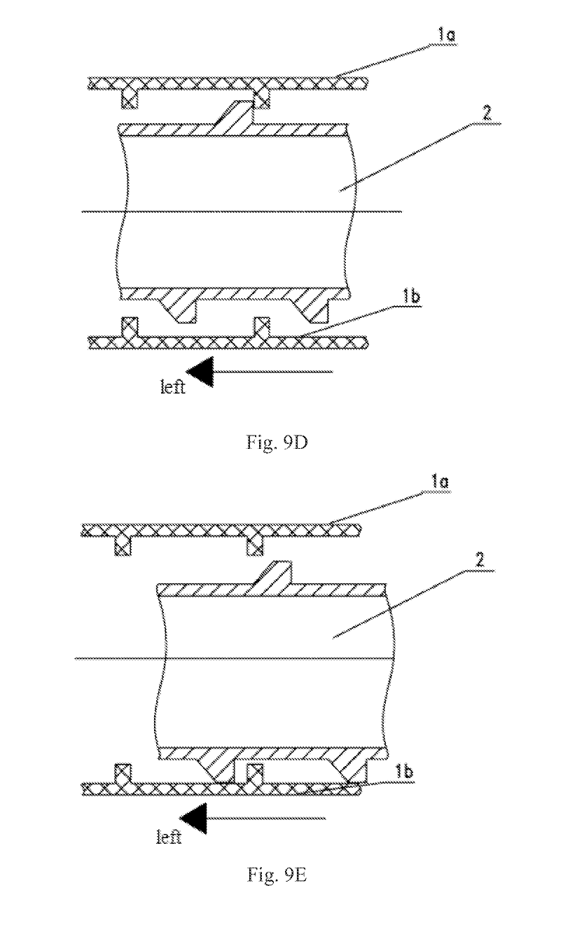

In the driving mode, the spool 2 is driven by the lower housing 1b through the cooperation of the set of driving teeth T3 and the set of lower projecting teeth T2. If the cutting line is worn or cracked, the cutting line needs to be fed out. To this end, when the portion 2a of the spool 2 which is exposed to the outer of the housing 1b is bumped, the spool 2 is applied with an upward force and will overcome the force of the spring 3 to move upwardly and the driving tooth T3 will be disengaged with the lower projecting tooth T2 as shown in FIG. 9B. The spool 2 will continue to rotate to the left under the centrifugal force of the cutting line, and the speed of the spool 2 is less than that of the upper housing 1a and the lower housing 1b as shown in FIG. 9C. The driving tooth T3 will continue to rotate to the left, and the upper projecting tooth T1 and the lower projecting tooth T2 will both rotate to the right with respect to the driving tooth T3 and the stopping tooth T4. When the upper projecting tooth T1 is rotated to the position shown in FIG. 9D, the spool 2 cannot rotate with respect to the housing 1a because of the stopping tooth T4, and now the spool 2 will move downwardly under the force of the stopping tooth T4, as shown in FIG. 9E. Then the lower projecting T2 will continue to rotate to the right with respect to the driving tooth T3 until the driving tooth T3 is engaged with the lower projecting tooth T2, and line feeding is complete.

In this embodiment, the trimmer head 100 is a bump-feed trimmer head, however, in other embodiments, the trimmer head may be manual-feed or auto-feed trimmer head.

In this embodiment, the spool 2 is driven by the lower housing 1b; however, in other embodiments, the spool 2 may be driven by the upper housing 1a.

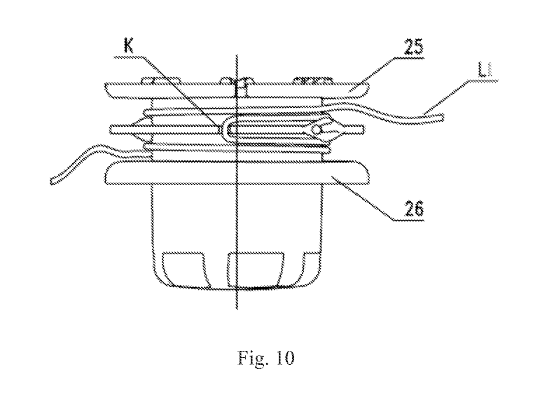

Further, as shown in FIG. 10, in this embodiment, a line gripping groove K is disposed on the flange 22 of the spool 2. In this way, if the upper housing and the lower housing are detached from each other, the operators can also utilize the line gripping slot K to wind the cutting line. Then, the cutting line can be wound on the trimmer head from outside of the housing or by separating the upper housing and the lower housing, to meet the needs of different users.

In conclusion, the cutting line can be wound on the spool without separating the upper housing and the lower housing. If two cutting lines are wound on the spool simultaneously, the two cutting lines will not be knotted to each other, which brings convenience to operators and improves operators' working efficiency. Also, the cutting line can be wound on the trimmer head from outside of the housing or by separating the upper housing and the lower housing, which meets the needs of different users.

The above illustrates and describes basic principles, main features and advantages of the described trimmer head. Those skilled in the art should appreciate that the described embodiments are not intended to be limiting. Rather, technical solutions obtained by equivalent substitution or equivalent variations all are intended to fall within the scope of the claims presented hereinafter.

What is claimed is:

1. A trimmer head, capable of being connected to a driving shaft of a string trimmer and being operated in a driving mode, a line winding mode and a line feeding mode, the trimmer head comprising:
a housing, adapted to be connected to the driving shaft, having a line outlet;
a spool, connected to the housing wherein, when in the driving mode, the spool is rotated with the housing, when in the line winding mode, the spool is rotatable relative to the housing and the spool includes an inwardly extending line leading channel whose diameter is larger than that of a cutting line, and in the line winding mode, the spool includes a position in which an end of the line leading channel is aligned with the line outlet and the cutting line is able to enter the line leading channel through the line outlet with the cutting line being in clearance fit with the line leading channel, and when the spool is rotated with respect to the housing, the portion of the cutting line in the line leading channel is pressed tightly therein, and the portion of the cutting line extending from the line leading channel is pulled toward the spool.

2. The trimmer head according to claim 1, wherein the spool includes a body and a flange projecting radially therefrom, the body is used for winding the cutting line and the line leading channel is disposed on the flange whereby, when the spool is rotated with respect to the housing, the portion of the cutting line in the line leading channel is pressed tightly therein, and the portion of the cutting line extending from the line leading channel is pulled toward the body of the spool.

3. The trimmer head according to claim 2, wherein the port of the line leading channel is funnel-shaped and tapers inwardly along an extending direction of the line leading channel.

4. The trimmer head according to claim 2, wherein when the end of the line leading channel is aligned with the line outlet an axis of the line leading channel forms an angle with respect to that of the line outlet.

5. The trimmer head according to claim 2, wherein a line gripping slot is disposed on the flange of the spool.

6. The trimmer head according to claim 2, wherein a guide surface is formed at the end portion of the line leading channel, and the guide surface is used for guiding a portion of the cutting line extending from the line leading channel towards the body of the spool.

7. The trimmer head according to claim 6, wherein the flange is formed at the middle portion of the circumference surface of the body and divides the body into a upper portion and a lower portion; the number of the line leading channels is two, and guide surfaces of the two line leading channels guide the cutting line extending from the line leading channel towards the upper portion and the lower portion respectively.

8. The trimmer head according to claim 2, wherein the trimmer head is a bump-feed trimmer head, the housing includes an upper housing and a lower housing, the upper housing is connectable to the driving shaft of a string trimmer, the lower housing and the upper housing are connected by a clip structure, a bottom portion of the spool is exposed outside of the lower housing, the body of the spool includes a set of upper projecting teeth and a set of lower projecting teeth, the lower housing includes a set of driving teeth cooperating with the set of lower projecting teeth, the upper housing includes a set of stopping teeth cooperating with the set of upper projecting teeth and wherein, in the driving mode, the spool is driven by the lower housing through the cooperation of the set of driving teeth and the set of lower projecting teeth, in the line winding mode, the set of driving teeth and the set of lower projecting teeth are disengaged, the set of upper projecting teeth will contact the set of stopping teeth, the spool will rotate for a first preset angle along a first direction with respect to the housing, and, in the line feeding mode, the set of driving teeth and the set of lower projecting teeth are disengaged, the set of upper projecting teeth will contact the set of stopping teeth, the spool will rotate for a second preset angle along a second direction with respect to the housing.

9. The trimmer head according to claim 8, wherein the set of upper projecting teeth and the set of lower projecting teeth are arranged uniformly on the end surfaces of the body of the spool, and the set of upper projecting teeth and the set of lower projecting teeth are staggered in the direction of the axis of the spool, the set of driving teeth and the set of the stopping teeth are aligned with each other in the direction of the axis of the spool.

10. The trimmer head according to claim 8, wherein the set of upper projecting teeth and the set of lower projecting teeth are arranged uniformly on the circumference of the body of the spool, and the set of upper projecting teeth and the set of lower projecting teeth are aligned with each other in the direction of the axis of the spool and the set of driving teeth and the set of the stopping teeth are staggered in the direction of the axis of the spool.

11. The trimmer head according to claim 8, wherein one side of the lower projecting tooth is inclined for disengaging with the driving tooth in the line winding mode, a same side of the upper projecting tooth is also inclined, and an opposite side of the driving tooth and the stopping tooth is inclined.
